(19) United States
(12) Patent Application Publication
(10) Pub. No.: US 2012/0278849 A1
(43) Pub. Date: Nov. 1, 2012

(54) CROSS CARRIER MLC SCHEDULING FOR MULTI-CARRIER NETWORKS IN THE PRESENCE OF MULTIPLE OPERATORS

(76) Inventors: Ralph A. GHOLMIEH, San Diego, CA (US); Gordon K. WALKER, Poway, CA (US)

(21) Appl. No.: 13/447,154

(22) Filed: Apr. 13, 2012

Related U.S. Application Data
(60) Provisional application No. 61/480,079, filed on Apr. 28, 2011.

(51) Int. Cl. H04N 21/262; H04W 72/04

(52) U.S. Cl. 725/126

(57) ABSTRACT

Receiver devices may receive broadcast content and decode data on multiple carriers in time division mode, and change carriers to receive data from different radio frequencies. Embodiments include methods, systems and devices that enable scheduling content for broadcast by two or more mobile TV broadcasters so that non-exclusive real time content broadcasts in one radio frequency band does not overlap with non-real time content broadcast in another radio frequency band, enabling simultaneous reception of non-real time broadcast by one network and non-exclusive real time content broadcast by another network. Receiver devices may simultaneously receive non-real time content on two or more radio frequency bands and real time content on any of the radio frequency bands.

### CROSS REFERENCE TO RELATED PATENT APPLICATIONS

This patent application claims the benefit of priority to U.S. Provisional Patent Application Ser. No. 61/480,079 entitled “Cross Carrier MLC Scheduling for Multi-Carrier Networks in the Presence of Multiple Operators” filed on Apr. 28, 2011, the entire contents of which are hereby incorporated by reference for all purposes.

### BACKGROUND

Wireless communication technologies have seen explosive growth over the past few years. This growth has been fueled by wireless services providing freedom of movement to the mobile public, and cutting the tether to hardwired communication systems. As a result of service enhancements, the popularity of wireless services is expected to continue to grow rapidly. A recent addition to wireless communication services has been the ability to broadcast television and other content to receiver devices. Mobile forward-link-only broadcast services allow users to view multimedia programming, such as television shows, as well as receive mobile editions of news, entertainment, sports, business, and other broadcast programming, using mobile receiver devices configured to receive the mobile broadcast transmissions. The growth of multimedia broadcast services represents an attractive communication platform for delivering a wide variety of content in various formats. With this growth in uses and popularity has come ever increasing demands on the bandwidth allocated to multimedia broadcast services. As more uses for broadcast bandwidth are deployed, there is greater need for increasing the utilization of the message formats and encoding methods used to carry multimedia broadcasts.

### SUMMARY

The various embodiments provide systems, devices, and methods for scheduling content for broadcast on two different radio frequencies (RFs) within a mobile TV broadcast system (e.g., Broadcast TV) such that non-exclusive real time (RT) content broadcast on one radio frequency does not overlap with non-real time (NRT) content broadcast on the other radio frequency. Various embodiments enable receiver devices (e.g., portable TVs) to simultaneously decode non-real time content (e.g., file delivery) on one radio frequency and non-exclusive real time content (e.g., NBC) on another radio frequency without conflicts to certain content broadcasts by time hopping between the two frequencies. Various embodiments enable two or more broadcasters to cooperate in broadcasting content required by law so that mandatory content can be effectively broadcast in markets in which the broadcaster signals are both present without the need redundant broadcasts which would reduce the utilization of bandwidth allocated to multimedia broadcasts. The various embodiments also include methods and systems for scheduling the broadcast streams, as well as receiver devices capable of changing carriers to simultaneously receive different types of data from different radio frequencies.

Further embodiments may include methods of broadcasting exclusive real-time content, non-exclusive real-time content, and non-real-time content within transmission frames on multiple radio frequency bands such that a receiver device associated with a first service provider may receive content broadcast on any two or more frequencies. In an embodiment, the method may include broadcasting non-real-time content exclusive to the first service provider in a first portion of transmission time on a transmission frame in a first radio frequency band and broadcasting exclusive and non-exclusive real-time content of the first service provider in a second portion of a transmission frame on any other radio frequency band. In an embodiment, exclusive real-time content, non-exclusive real-time content, and non-real-time content may also be broadcast for a second provider. In a further embodiment, the method may include broadcasting non-real-time content exclusive to the second provider in a third portion of transmission time of a transmission frame in a first radio frequency band such that the non-real-time transmissions of the first and second provider do not overlap. In an embodiment, the method may further include broadcasting exclusive and non-exclusive real-time content of the second provider in a second portion of a transmission frame on any other radio frequency band such that the exclusive and non-exclusive real time content do not overlap in time with the third portion of the frame.

Further embodiments include broadcast systems that may include a first content provider server and a second content provider server, the first and second servers being configured with server-executable instructions to perform operations corresponding to various embodiment methods. Even further embodiments include computing devices that may have a processor configured with processor-executable instructions to perform operations for accomplishing the various embodiment methods. Further embodiments include a computing device having various means for performing functions corresponding to the various embodiment methods. Further embodiments include a non-transitory processor-readable storage medium having stored thereon processor-executable instructions configured to cause a processor to perform operations for accomplishing the various embodiment methods.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a communication system block diagram illustrating communication paths in a typical multimedia broadcast communication system suitable for use with the various embodiments.

FIG. 2 is a system block diagram of transmitter systems and receiver devices suitable for use with the various embodiments.

FIG. 3 is a process flow diagram of an embodiment method for scheduling the transmission of both real time and non-real time content simultaneously across two or more carriers.

FIGS. 4-7 are frequency allocation diagrams of four alternative example broadcast frame allocations for allocating content broadcast by two or three service providers over three carriers from implementing embodiment methods illustrated in FIG. 3.

FIG. 8 is a system block diagram of a receiver device suitable for use with any of the embodiments.

FIG. 9 is a system block of a broadcast-side server suitable for use with any of the embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

The terms “mobile device,” “receiver device” and “receiver” are used interchangeably herein to refer to any one or all of mobile media broadcast receivers, cellular telephones, personal television devices, personal data assistants (PDA's), palm-top computers, wireless electronic mail receivers (e.g., the Blackberry® and Treo® devices), multimedia Internet enabled cellular telephones (e.g., the Blackberry Storm®), Global Positioning System (GPS) receivers, wireless gaming controllers, receivers within vehicles (e.g., automobiles) and similar personal electronic devices which include a programmable processor and memory and broadcast/forward-link-only mobile TV broadcast receiver circuitry for receiving and processing broadcast transmissions.

The word “broadcast” is used herein to mean the transmission of data (e.g., information packets) so that it can be received by a large number of receiving devices simultaneously, and may include multicast. Examples of broadcast messages are mobile television service broadcast signals, including content broadcasts (content flow) and overhead information broadcasts (overhead flow) such as metadata messages.

The term “frame” is used generically herein and may include any structure that comprises signals within a frequency band and within set time boundaries, such as Advanced Television Systems Committee—Mobile/Handheld (ATSC M/H) frames, MediaFLO® superframes, and Long Term Evolution (LTE) Evolved Multimedia Broadcast and Multicast Services (eMBMS) frames and/or superframes.

For clarity, various embodiments are discussed using orthogonal frequency division multiplexing (OFDM) terminology. However, it should be understood that the various embodiments may be implemented on any time division multiplexing (TDM) system, and nothing in the claims should be understood as being limited to OFDM technology, unless expressly recited by the claims.

As used herein, the terms “exclusive” and “exclusive content” refer to broadcast content that is available on only one broadcaster's network. As used herein, the terms “non-exclusive” and “non-exclusive content” refer to broadcast content that is not the property or under the control of anyone broadcaster network, and more particularly refers to content that should be available to all receiver devices in the interest of public safety and/or government regulations. More specifically, exclusive content is that which is proprietary to a single provider, while non-exclusive content is content that is available to everyone. For example, a Game Show channel may be exclusive to a single provider, whereas a government information broadcast may be non-exclusive so all receiver devices can receive it.

A number of different mobile broadcast television services and broadcast standards are available or contemplated in the future, all of which may implement and benefit from the various embodiments. Such services and standards include, e.g., Open Mobile Alliance Mobile Broadcast Services Enabler Suite (OMA BCAST), MediaFLO®, Digital Video Broadcast IP Datacasting (DVB-IPDC), Digital Video Broadcasting-Handheld (DVB-H), Digital Video Broadcasting-Satellite services to Handhelds (DVB-SH), Digital Video Broadcasting-Handheld 2 (DVB-H2), Advanced Television Systems Committee-Mobile/Handheld (ATSC-M/H), and China Multimedia Mobile Broadcasting (CMMB). Each of these broadcast formats involves a broadcast communication channel. For ease of reference, the various embodiments are described with reference to a particular broadcast system, namely the MediaFLO® system, which is implemented in the FLO TV® broadcast systems. However, references to FLO TV® and MediaFLO® terminology and technical details are for illustrative purposes only and are not intended to limit the scope of the claims to a particular broadcast communication system or technology unless specifically recited in the claim language. The following descriptions and the claims should be understood as applicable to broadcast and broadcast systems including, in particular, multicast and multicast systems.

Generally, content and data may be transmitted to receiver devices through either a broadcast based communication system or a “point-to-point” communication system. Point-to-point communication systems typically use a request/response method of communication, whereby device applications connect to a well known server, request data, download the requested data, and use the downloaded data to present users with updated information and/or services. Broadcast systems, on the other hand, do not require receiver devices to connect to a server and/or expressly request data. Rather, in broadcast systems, data is periodically transmitted over the network for reception by all receivers. Individual receiver devices either continuously listen for the data or periodically “wake up” at scheduled times to selectively receive the data being broadcast. Since broadcast systems may continuously transmit data, the broadcast medium is better suited to transmit real time content (e.g., audio and video). To meet the increasing demands of a mobile public, the broadcast medium may now also be used to transmit non-real time content (e.g., applications data and file delivery services) simultaneously with the real time content.

Receiver devices that receive broadcast content can typically decode data on multiple carriers in time division mode, and may change carriers to receive data from different radio frequencies. As discussed above, a broadcast network may broadcast both real time and non real time content simultaneously. As such, in certain situations, a user may operate their receiver device in a manner that requires it to decode both real time and non-real time flows simultaneously. The various embodiments provide methods, systems, and devices capable of broadcasting and receiving the non-real time and real time content such that a receiver device can receive and decode at least one real time flow and one non-real time flow simultaneously across radio frequencies in a multi-carrier system.

In addition to normal commercial content, government mandates in some markets require that certain types of non-exclusive content be available to all receiver devices at all times. For example, in some markets, broadcasters may be required to ensure that citizens can receive public safety announcement broadcasts, certain public interest or government sponsored broadcasts (e.g., political debates or speeches), etc. As another example, governments may require that mobile TV broadcasters make available to all receiver devices the same channels as broadcast over-the-air to conventional televisions, (e.g., NBC, CBS and ABC in the United States). If a government mandate that non-exclusive real time content be available to all receiver devices is imposed on every provider, this would require them to broadcast the same real time content, even though the same broadcast is available from other providers. Such redundant broadcasts would reduce the total bandwidth available for mobile broadcast television. To avoid such duplication of broadcast, the various embodiments allow two or more providers in the same broadcast area (e.g., Tokyo) to cooperate so that only one radio frequency is used to carry each non-exclusive real time program. As a result, more bandwidth is available for carrying real time programming (both exclusive and non-exclusive) when two or more providers operate in the same geographic area. By cooperating, two or more broadcasters can ensure that any receiver device in the overlapping coverage area is able to receive the mandated non-exclusive real time broadcasts. That is, the various embodiments enable broadcast streams to be scheduled in a manner that allows providers to divide, amongst themselves, the obligation of carrying non-exclusive real time content. For example, two providers may enter into an agreement wherein the first provider agrees to carry a first non-exclusive real time content (e.g., NBC) in exchange for the second provider's carrying a second non-exclusive real time content (e.g., ABC). In this manner, each provider's respective customers can access the non-exclusive real time content broadcast by the other provider. Such agreements may result in better bandwidth utilization and improved efficiency.

In order to divide up the burden of carrying the non-exclusive real time content, the various embodiments provide methods for ensuring that receiver devices (e.g., mobile TVs) can access multiple radio frequencies without conflict between non-real time content and non-exclusive real time content. The various embodiments also provide a common method of decoding the content on the different radio frequencies. Decoding content on the different radio frequencies is typically not a problem in single carrier broadcast systems, because single-carrier based devices can normally decode both real time and non-real time flows simultaneously. However, in multi-carrier broadcast systems, such as time division multiplexing (TDM) and orthogonal frequency division multiplexing (OFDM) based systems, conflicts may arise when a device desires to receive a non-real time flow on one carrier and a real time flow on another carrier. Thus, the various embodiments provide methods that allow decoding both real time and non-real time data flows simultaneously in multi carrier markets.

As mentioned above, in multi-provider situations, where two or more broadcasters are broadcasting content on two or more radio frequencies bands, simultaneous decoding of content across radio frequencies can result in reception challenges. For example, when a receiver device attempts to receive content from two broadcasters by rapidly changing frequencies for receiving signals within frames (referred to herein as “time hopping”), conflicts may arise when the device tries to simultaneously receive a non-real time flow on one radio frequency band (e.g., from a first broadcaster) and a real time flow on another radio frequency band (e.g., from a second broadcaster). The various embodiments provide methods, systems and devices for coordinating the transmitting non-real time flows and non-exclusive real time flows in multi-carrier markets without encountering conflicts that would otherwise require redundant broadcasts. The various embodiments allow receiver devices (e.g., portable TVs) to simultaneously decode non-real time content (e.g., a file delivery flow) on one radio frequency and non-exclusive real time content (e.g., NBC) on another radio frequency by time hopping between the two receivers. The various embodiments as also encompass receiver devices capable of simultaneously receiving different types of data from different radio frequency bands.

TDM and/or OFDM-based communication systems may use a transmission structure in which data is transmitted in frames or superframes, with each frame having a finite time duration. For example, in OFDM-based systems, each frame may comprise signals within a frequency band and within set time boundaries that encode a plurality of data packets that communicate the broadcast content along with overhead information used by receiver devices to receive selected content. For instance, in the MediaFLO® broadcast system, broadcast transmissions are organized into one-second superframes spanning a frequency band (for example 716 MHz to 722 MHz). Different types of data (e.g., traffic/packet data, overhead/control data, pilot, and so on) may be sent in different parts of each frame or superframe. Each frame includes a portion dedicated to the overhead flow and a portion that carries multiple channels associated with content flows. As another example, in OFDM-based systems, information within the overhead flow and other overhead streams (e.g., a control channel) informs receiver devices of where (e.g., frequency) and when (e.g., time or frame) within the frame that a particular content flow can be obtained, as well as how many packets are associated with the streams of that content flow. Likewise, communication systems operating multicast/broadcast over single-frequency network, such as Long Term Evolution (LTE) Evolved Multimedia Broadcast and Multicast Services (eMBMS), may have similar TDM data access structures. In any case, in many TDM and/or OFDM-based communication systems, multiple broadcasters may operate in the same market by broadcasting their content on separate frequency bands. Consequently, receiver devices in such multi-provider networks may have available to them multiple real and non-real time content flows broadcast simultaneously on multiple distinct frequency bands.

Mobile multi-media broadcasters may organize their broadcast transmissions so that their subscriber receiver devices can receive both real time and non-real time content. This is accomplished by broadcasting real time content symbols at a different time segment (e.g., time within a broadcast frame) than transmissions of non-real time content. Receiver devices receive the two types of content by selectively receiving and processing two different portions of each frame by switching between the two frequencies in accordance with the timing of the desired symbols within frames (time hopping). The various embodiments presume that receiver devices will only receive one real time content flow at a time. This is because real time content is displayed as it is received (e.g., in real time), thus requiring the receiver's display and speakers. Non-real time content, such as text, website feeds, software updates, etc. may be bundled together or involve short communications (e.g., one or a few frames worth of data), thus, this presumption is not necessary or meaningful for non-real time content broadcasts.

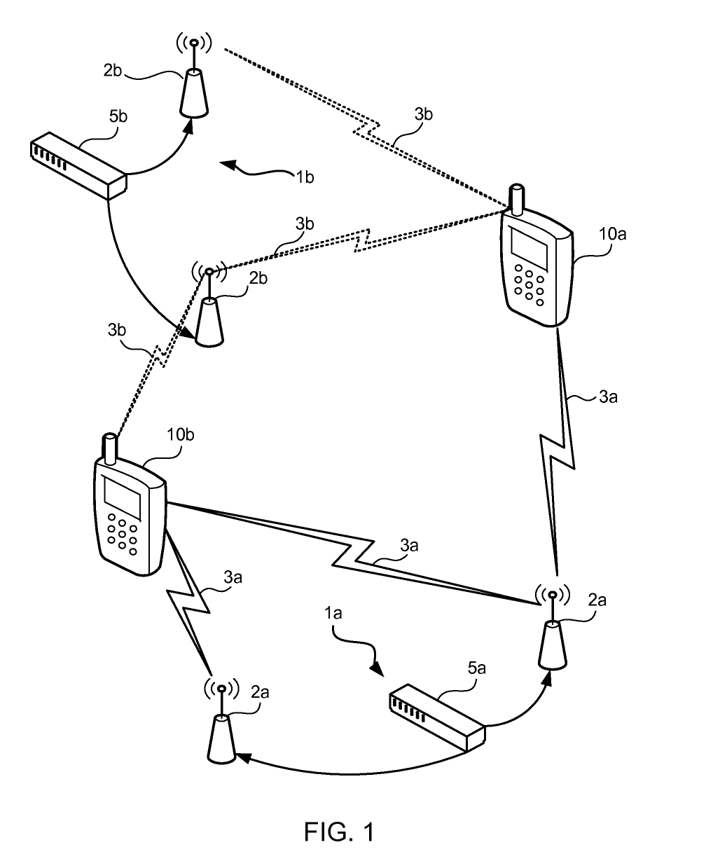

An example multi-broadcaster communication system including two broadcast networks 1a and 1b is illustrated in FIG. 1. Each mobile broadcast television system 1a, 1b may include a plurality of transmission towers 2a, 2b connected to a broadcast system 5a, 5b. The transmission towers 2a, 2b broadcast radio frequency signals 3a, 3b for reception by communication devices 10a, 10b. The receiver devices 10a, 10b are able to distinguish the two simultaneous broadcasts 3a, 3b because they are transmitted in different frequency bands (e.g., receivers only receive signals from the frequency band to which they are tuned).

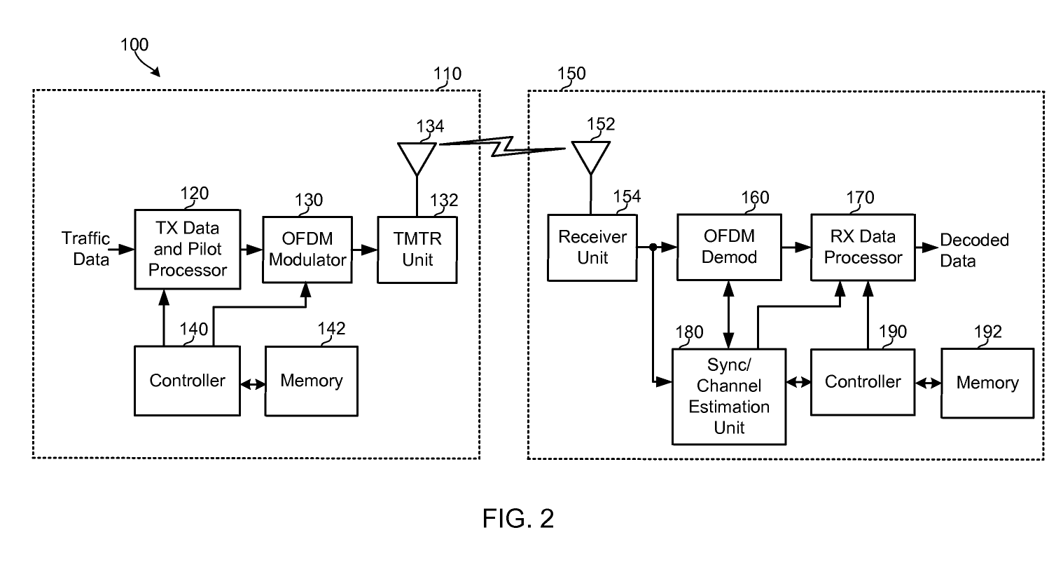

FIG. 2 illustrates a block diagram of a base station 110 of a multimedia broadcast network 2a, 2b and a wireless receiver device 150 in a typical OFDM mobile multimedia communication system 100. The base station 110 is generally a fixed station and may also be referred to as a base transmitter system (BTS), an access point, or by some other term. A wireless receiver device 150 may be fixed or mobile. At the base station 110, a transmitter (TX) data and pilot processor 120 receives different types of data (e.g., real time and non-real time content, and overhead/control data) and processes (e.g., encodes, interleaves, and symbol maps) the received data to generate data symbols. As used herein, a “data symbol” is a “modulation symbol” for data. As used herein, a modulation symbol is a complex value for a point in a signal constellation for a modulation scheme (e.g., M-PSK, M-QAM, and so on). The pilot processor 120 also generates pilot symbols and provides the data and pilot symbols to an OFDM modulator 130.

The OFDM modulator 130 multiplexes the data and pilot symbols onto the proper sub-bands and symbol periods and performs OFDM modulation on the multiplexed symbols to generate OFDM symbols. A transmitter (TMTR) unit 132 converts the OFDM symbols into one or more analog signals, and further conditions (e.g., amplifies, filters, frequency upconverts, etc.) the analog signal(s) to generate a modulated signal. The base station 110 transmits the modulated signal from an antenna 134 for reception by wireless receivers in the OFDM system 100.

At the wireless receiver device 150, the transmitted signal from base station 110 is received by an antenna 152 and provided to a receiver unit 154. The receiver unit 154 conditions (e.g., filters, amplifies, frequency downconverts, etc.) the received signal, and digitizes the conditioned signal to obtain a stream of input samples. The receiver unit 154 is further configured to be able to switch between two or more frequencies within short time intervals in order to be able to receive symbols from two or more different carriers within a single frame (time hopping). An OFDM demodulator 160 performs OFDM demodulation on the input samples to obtain received data and pilot symbols. The OFDM demodulator 160 also performs detection (e.g., matched filtering) on the received data symbols with a channel estimate (e.g., a frequency response estimate) to obtain detected data symbols, which are estimates of the data symbols sent by base station 110. The OFDM demodulator 160 provides the detected data symbols to a receive (RX) data processor 170.

A synchronization/channel estimation unit (SCEU) 180 receives the input samples from the receiver unit 154 and performs synchronization to determine frame and symbol timing, as described below. The SCEU 180 also derives the channel estimate using received pilot symbols from the OFDM demodulator 160. The SCEU 180 provides the symbol timing and channel estimate to the OFDM demodulator 160 and may provide the frame timing to the RX data processor 170 and/or a controller 190. The OFDM demodulator 160 uses the symbol timing to perform OFDM demodulation and uses the channel estimate to perform detection on the received data symbols.

The RX data processor 170 processes (e.g., symbol demaps, deinterleaves, decodes, etc.) the detected data symbols from the OFDM demodulator 160 and provides decoded data. The RX data processor 170 and/or controller 190 may use the frame timing to recover different types of data sent by the base station 110. In general, the processing by the OFDM demodulator 160 and the RX data processor 170 is complementary to the processing by the OFDM modulator 130 and the TX data and the pilot processor 120, respectively, at the base station 110.

Controllers 140, 190 may direct operations at the base station 110 and the wireless receiver device 150, respectively. The controllers 140, 190 may be processors and/or state machines. Memory units 142, 192 may provide storage for program codes and data used by controllers 140 and 190, respectively. The memory units 142, 192 may use various types of storage medium to store information.

In a multimedia mobile TV broadcast system, the base station 110 sends broadcast transmissions, including overhead/control data and multiple content streams, to all wireless receivers within its coverage area.

In a multi-broadcaster market, more than one base station is present, each broadcasting its own content streams and overhead/control data within its own frequency band. In the various embodiments, the receiver devices 150 are configured to enable the receiver unit 154 to receive signals from multiple base stations 110 broadcasting in different frequency bands. This may be accomplished by the receiver device controller 190 directing the receiver unit 154 to tune to the correct frequency band to receive signals from a particular one of the base stations 110 at time the desired content appears in a frame. The various embodiments are enabled by configuring the receiver device controllers 190 (e.g., with processor-executable instructions) to tune to the frequency bands of two or more base stations 110 in order to receive their respective overhead/control data transmissions. Then using the transmission frequency/time information from the overhead/control data, the receiver controller 190 can direct the receiver unit 154 to tune to the appropriate portion of one of the two (or more) frequency bands at the appropriate instant or frame within each frame in order to receive the real or non-real time content from one base station 110. By rapidly tuning between the frequencies of the two base stations 110 at the appropriate instant in each frame, receiver devices can receive non-real time content data signals from one base station 110 and real time content from another base station 110. (Receiver devices may also receive non-real time content from two or more broadcasters, however, the non-real time nature of such transmissions do not require the timing coordination of the various embodiments). Because the various embodiments ensure that non-exclusive real time content is not broadcasted at the same time as non-real time content, so configured receiver devices are able to always receive non-exclusive real time content, regardless of the broadcast network transmitting such content.

As mentioned above, the various embodiments provide for scheduling the broadcast of non-real time content, exclusive real time content and non-exclusive non-real time by two or more broadcasters (e.g., in each of two or more radio frequency bands) so that non-exclusive real time content is never broadcast in one radio frequency band at the same time within each frame as non-real time content is broadcast in another radio frequency band. This enables any mobile receiver device to be able to switch frequencies between the two frequency bands in order to receive non-real time content from one broadcaster and non-exclusive real time content from the other broadcaster.

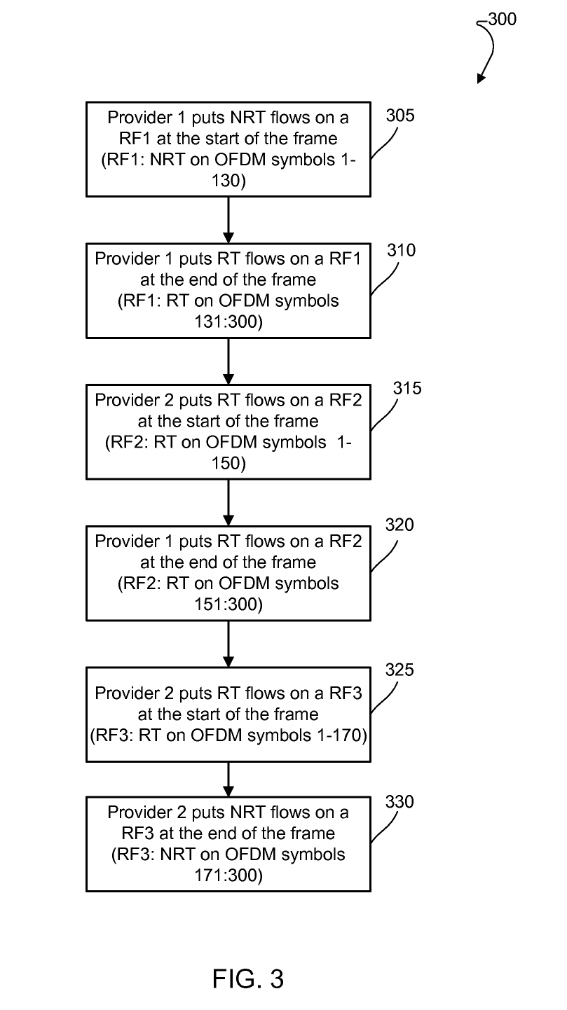

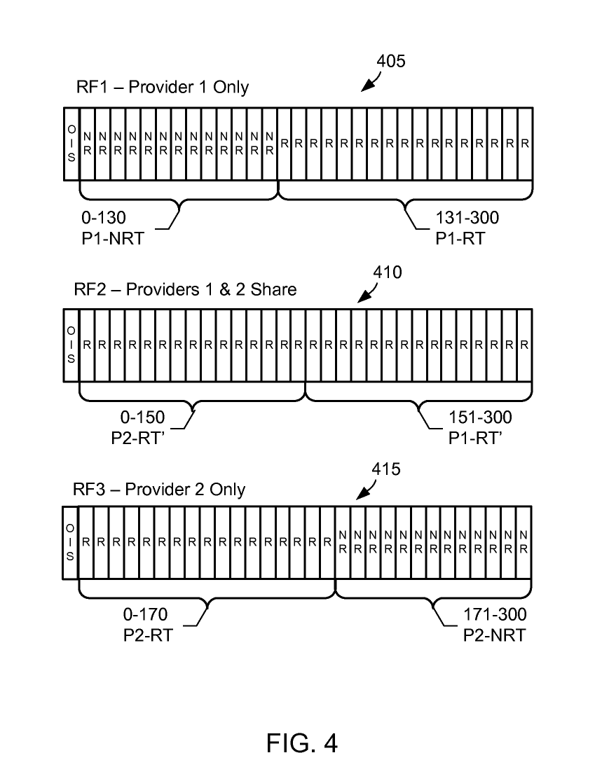

FIG. 3 illustrates an embodiment method 300 for scheduling the transmissions of real time and non-real time content simultaneously across two or more carriers. FIG. 4 illustrates example frames resulting from implementation of method 300. These figures illustrate an example situation in which two providers (e.g., multimedia broadcasters) broadcast over three radio frequency bands. Through the cooperation of the two broadcasters, the three radio frequency bands are used to transmit exclusive real time content, non-exclusive real time content, and non-real time content such that no two providers broadcast non-real time data at the same time as non-exclusive real time content.

In step 305, non-real time content for Provider 1 (P1-NRT) may be placed on a first radio frequency band (RF1), at the start of a frame. Then, in step 310, Provider 1's exclusive real time content (P1-RT) may be placed at the end of the same frame, on the same frequency band (RF1).

FIG. 4 illustrates an example frame (405) resulting from steps 305 and 310. As can be seen from FIG. 4, in frame 405, both the non-real time content and the exclusive real time content may be placed in the same radio frequency band (RF1), but in different OFDM symbol groups. For instance, P1-NRT may be grouped together near the start of the frame (OFDM symbols 0-130); whereas P1-RT may be placed near the end of the frame (OFDM symbols 131-300). It should be noted that in the illustrated example, RF1 only carries the flows that are exclusive to Provider 1 and RF3 only carries the flows that are exclusive to Provider 2.

Returning to FIG. 3, in step 315, the non-exclusive real time content of Provider 2 (P2-RT′) may be transmitted in a second radio frequency band (RF2), at the start of the frame 410. Then, the non-exclusive real time content of Provider 1 (P1-RT′) may be transmitted on RF2 (step 320), at the end of the frame 410. This is illustrated in FIG. 4, where frame 410 is partitioned into two sections: P2-RT in the beginning symbols (e.g., OFDM symbols 0-150); and P1-RT in the remaining symbols (e.g., OFDM symbols 151-300). FIG. 4 also illustrates that frequency band RF2 may be shared by both providers (Providers 1 & 2) and may only carry non-exclusive real time content (P2-RT′ and P1-RT′).

In step 325, the exclusive real time content (P2-RT) of Provider 2 may be transmitted in a third radio frequency band (RF3), at the start of each frame 415. In step 330, provider 2's non-real time content (P2-NRT) may be transmitted near the end of each frame 415. As mentioned above, in the example in illustrated FIG. 4, frequency band RF3 only carries content that is exclusive to Provider 2 (P2-RT and P2-NRT).

FIG. 4 also illustrates overhead information symbols (OIS) transmitted at the very beginning of each frame 405, 410, and 415. The OIS provides overhead information that receiver devices use to receive content broadcast in the frequency bands. In the various embodiments, the locate OIS may also provide information on the location (e.g., frequency and time) of each content symbols within the frame (sub-frame). The OIS may also provide information on the frequencies of other frequency bands as well as the locations within frames transmitted in other frequency bands of non-exclusive real time content. This information would enable receiver devices to determine from the OIS received in one frequency band the frequencies and frame timing of non-exclusive content being transmitted in other frequency bands. Thus, in addition to cooperating in terms of broadcasting non-exclusive real time content and non-real time content in different portions of frames, broadcasters in multi-provider markets may also cooperate in broadcasting OIS messages that provide information regarding the non-exclusive content available on other broadcasters' networks.

In summary, FIGS. 3 and 4 illustrate how the various embodiments ensure that the exclusive real time content and the non-real time content are transmitted within frames so that no two providers broadcast non-real time content at the same time that non-exclusive real time content is being broadcast on any one of the two or more radio frequency bands. This allows a receiver device (e.g., portable TV) to monitor the non-real time content transmitted in one radio frequency band and non-exclusive real time content transmitted in a different radio frequency band on one receiving chain (e.g., one receiver circuit).

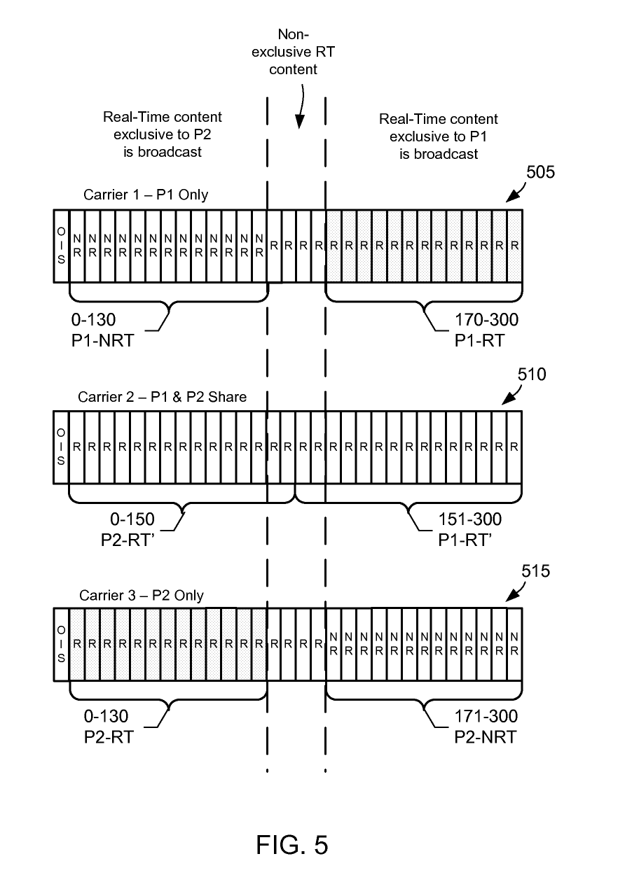

FIG. 5 illustrates an alternative embodiment in which the bandwidth of three frequencies or carriers 505, 510, and 515 is shared between two providers P1, P2 so that a receiver subscribed to both providers may receive the services of both providers without interference. Specifically, FIG. 5 illustrates how a receiver device subscribing to both providers (P1 and P2) can access all the real-time content broadcast by both providers without any interference or conflicts from non-real-time content also destined for this subscriber on the same receiver chain. In this example both the non-real time content and the exclusive real time content may be placed in the same radio frequency band, but in different OFDM symbol groups. For instance, on a first carrier 505, non-real time content from the first provider P1 may be grouped together near the start of the superframe (OFDM symbols 0-130); non-exclusive real-time content the first provider P1 may be grouped in a middle of the frame (OFDM symbols 131-169); and exclusive real-time content of the first provider P1 may be grouped at the end of the frame (OFDM symbols 170-300). Likewise, on a third carrier 515, exclusive real time content from the second provider P2 may be grouped together near the start of the frame (OFDM symbols 0-130); non-exclusive real-time content of the second provider P2 may grouped in the middle of the frame (OFDM symbols 131-169); and non-real-time content of the second provider P2 may be grouped at the end of the frame (OFDM symbols 170-300). In order to facilitate the transmission of non-exclusive real-time content, a third carrier 510 may be shared by both providers P1 and P2. To enable this the third carrier 510 may be partitioned into two sections, with the non-exclusive real-time content of the second provider P2 being transmitted in the beginning symbols (e.g., OFDM symbols 0-150), and the non-exclusive real-time content of the first provider P1 being transmitted in the remaining symbols (e.g., OFDM symbols 151-300). FIG. 5 also illustrates that a carrier band may be shared by both providers (Providers 1 and 2) and carry non-exclusive real time content (P2-RT′ and P1-RT′).

In this manner, a subscriber to any two providers can access all the real-time content to which the receiver device is subscribed without conflict with any non-real-time downloads also destined for the subscriber using a single receiver chain. FIG. 5 also illustrates that, in accordance with the various embodiments, non-exclusive real-time flows may be transmitted such that they do not conflict with any non-real-time flows on other frequencies (from any other provider). The various embodiments enable the non-exclusive real-time flows to be placed in an area of the carriers 505, 510, 515 that does not conflict in time with any other non-real-time broadcasts on any of the three frequencies and/or carriers 505, 510, 515. By separating the real time contents of the two service providers in time within each frame, there is enough time separation to allow receiver devices to switch radio frequencies (RF) in order to switch from one real time content on one carrier to the real time content on another carrier without missing a frame.

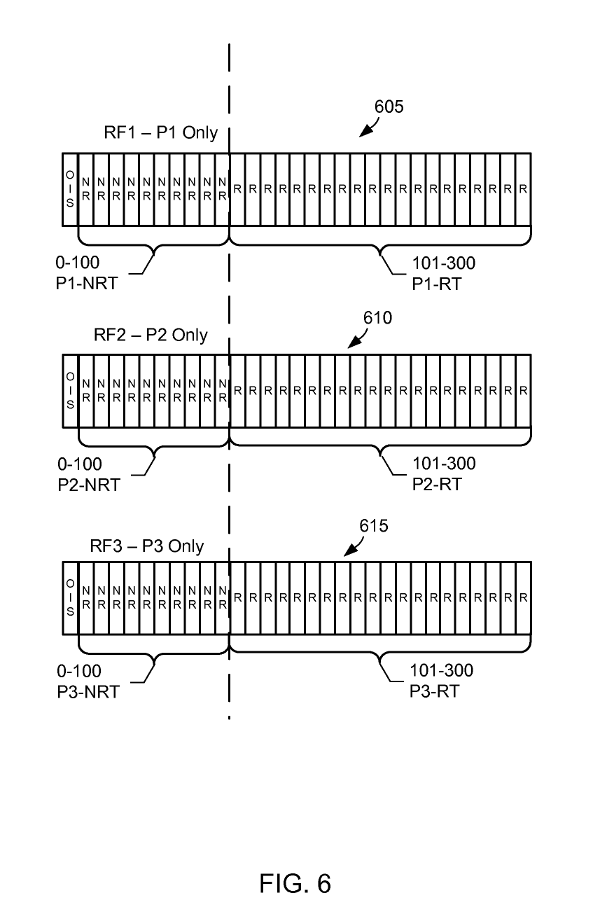

FIG. 6 illustrates another example implementation of the various embodiments in which the bandwidth of three radio frequencies or carriers 605, 610, and 615 is allocated to three providers P1, P2, P3 and coordinated so that a receiver device subscribed to all three providers may receive data from all three providers without interference or conflicts. Specifically, FIG. 6 illustrates that the non-real-time content from each of the three providers P1, P2, P3 can be placed onto the beginning of the frame (e.g., OFDM symbols 0-100) and the non-exclusive real-time content may be grouped at the end of the frame (OFDM symbols 101-300) on each of the three radio frequencies RF1, RF2, RF3. By overlapping the non-real-time content of all three providers, a subscriber to all three providers will not be subjected to conflicts arising from the concurrent transmissions.

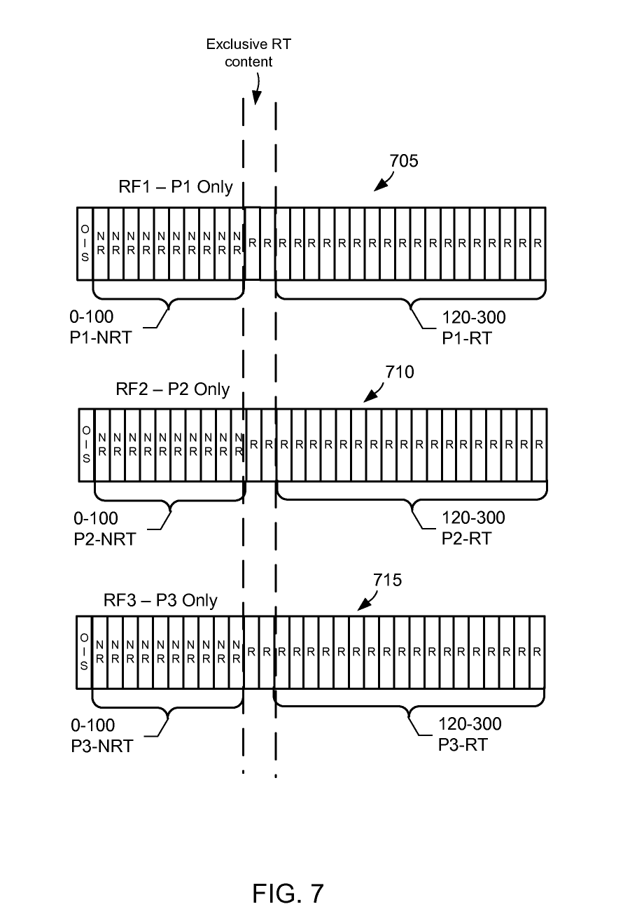

FIG. 7 illustrates another example implementation of the various embodiments in which the bandwidth of three radio frequencies or carriers 705, 710, and 715 are allocated to three providers P1, P2, P3 and coordinated so that a receiver device subscribed to all three providers may receive data from all three providers without conflicts or interference. In the illustrated example, the radio frequencies RF1, RF2, RF3 carry exclusive real-time content in addition to the non-real-time content and the non-exclusive content. By broadcasting exclusive real-time content immediately after the non-real-time content within each frame, receiver devices can receive the non-real-time content of one provider while simultaneously receiving a real-time content from another provider. This is because receivers would have time to switch frequencies (e.g., from one of frequencies RF1, RF2, RF3 to another) between the time slots within frames containing non-real-time symbols (e.g., symbols 0-100) to the time slots within frames containing non-real-time symbols (e.g., symbols 120-300). In this implementation the non-real-time transmissions on the three carriers 705, 710, and 715 will not have to overlap exactly. This may be the case when the transmissions are slightly off synch. To accommodate this and to ensure there is sufficient time for RF switching by receivers, a guard time may be provided in the symbol allocation scheme to allow receivers to switch frequencies. For example, FIG. 7 illustrates how a guard time portion of each frame may be provided positioned in time between time slots allocated to the non-real-time content and time slots allocated to non-exclusive real-time content by assigning these time slots to exclusive real-time content on all three radio frequencies 705, 710, and 715. This portion of the frame allocated to exclusive content to provide a guard time may overlap other non-real-time transmissions on other radio frequencies and may be assigned to those time slots within frames which are not far enough in time from a non-real-time transmission time to accommodate the radio frequency switching latencies of receiver devices.

The various embodiments may include a method of broadcasting exclusive real-time content, non-exclusive real-time content, and non-real-time content within transmission frames on a first, second, and third radio frequency band so that a receiver device may receive content broadcast on any two of the three frequencies. In various embodiments, the method may include the steps of: broadcasting a first non-real time content in a first portion of transmission frames in the first radio frequency band; broadcasting a first exclusive real time content in a second portion of transmission frames in the first radio frequency band; broadcasting a first non-exclusive real time content in a second portion of transmission frames in the second radio frequency band; broadcasting a second non-exclusive real time content in a first portion of transmission frames in the second radio frequency band; broadcasting a second exclusive real time content in a first portion of transmission frames in the third radio frequency band; and broadcasting a second non-real time content in a second portion of transmission frames in the third radio frequency band, where the first non-real time content and the first exclusive real time content are transmitted so that transmission of the first non-real time content in the first radio frequency band and the transmission of the second non-real time content in the third radio frequency band does not overlap in time and so that broadcast content may be received on a single receiver chain without conflict.

In various embodiments, the first non-real time content, the first exclusive real time content, and the first non-exclusive real time content may be broadcast by a first content provider, and the second non-real time content, the second exclusive real time content, and the second non-exclusive real time content may be broadcast by a second content provider. Various embodiments may include scheduling the transmission of the first non-real time content such that the first non-real time content is transmitted at the same time as the second exclusive real time content. Various embodiments may include scheduling the transmission of the second non-real time content such that the second non-real time content is transmitted at the same time as the first exclusive real time content. Various embodiments may include scheduling the transmission of the first non-real time content such that neither the first non-real time content nor the second non-real time content is transmitted at the same time as either the first non-exclusive real time content or the second non-exclusive real time content. Various embodiments may include broadcasting the first non-exclusive real time content in a third portion of transmission frames in the first radio frequency band, the third portion of transmission frames in the first radio frequency band being positioned in time between the first and second portions of transmission frames in the first radio frequency band, and broadcasting the second non-exclusive real time content in a third portion of transmission frames in the third radio frequency band, the third portion of transmission frames in the third radio frequency band being positioned in time between the first and second portions of transmission frames in the third radio frequency band.

The various embodiments may also include tuning receiver circuitry in a receiver device to the first radio frequency band to receive the first non-real time content transmitted in the first portion of transmission frames in the first radio frequency band, and tuning the receiver circuitry in the receiver device to the third radio frequency band in time to receive the second non-exclusive real time content transmitted in the third portion of transmission frames in the third radio frequency band. Various embodiments may include receiving in the receiver device overhead information symbols transmitted in the first frequency and determining from the received overhead information symbols frequency and timing information to enable tuning the receiver circuitry in the receiver device to the third radio frequency band to receive the second non-exclusive real time content.

In various embodiments, scheduling the first non-real time content for broadcast in the first radio frequency band and scheduling the second non-exclusive real time content for broadcast in the second radio frequency band may be coordinated so that non-real time content and real time content are not scheduled for transmission in the same portion of transmission frames. In various embodiments, overhead information symbols transmitted in the second frequency may be received in a receiver device such that the system may determine from the received overhead information symbols frequency and timing information to enable tuning the receiver circuitry in the receiver device to either the first or third radio frequency band to receive the first or second non-real time content transmitted in the first portion of transmission frames in either the first or third radio frequency band.

Various other embodiments may include a method of broadcasting non-exclusive real-time content and non-real-time content on transmission frames on a first, second, and third radio frequency band such that a receiver device may simultaneously receive broadcast content from all three frequencies. In various embodiments, this method may include the steps of: broadcasting a first non-real time content in a first portion of transmission frames in the first radio frequency band; broadcasting a first non-exclusive real time content in a second portion of transmission frames in the first radio frequency band; broadcasting a second non-real time content in a first portion of transmission frames in the second radio frequency band; broadcasting a second non-exclusive real time content in a second portion of transmission frames in the second radio frequency band; broadcasting a third non-real time content in a first portion of transmission frames in the first radio frequency band; and broadcasting a third non-exclusive real time content in a second portion of transmission frames in the first radio frequency band, where the broadcasts on the first, second and third radio frequency bands are coordinated such that a single receiver chain can receive non-real time content broadcast on any one of the first, second and third radio frequency bands at the same time it receives non-real time content broadcast on any one of the first, second and third radio frequency bands.

In various embodiments, the first non-real time content and the first non-exclusive real time content may be broadcast so that the first non-real time content in the first radio frequency band and the third non-real time content in the third radio frequency band overlap in time and such that broadcast content may be received on a single receiver chain without conflict. Various embodiments may include the steps of: broadcasting a first exclusive real time content in a third portion of transmission frames in the first radio frequency band, the third portion of transmission frames in the first radio frequency band being positioned in time between the first and second portions of transmission frames in the first radio frequency band; broadcasting a second exclusive real time content in a third portion of transmission frames in the second radio frequency band, the third portion of transmission frames in the second radio frequency band being positioned in time between the first and second portions of transmission frames in the second radio frequency band; and broadcasting a third exclusive real time content in a third portion of transmission frames in the third radio frequency band, the third portion of transmission frames in the third radio frequency band being positioned in time between the first and second portions of transmission frames in the third radio frequency band.

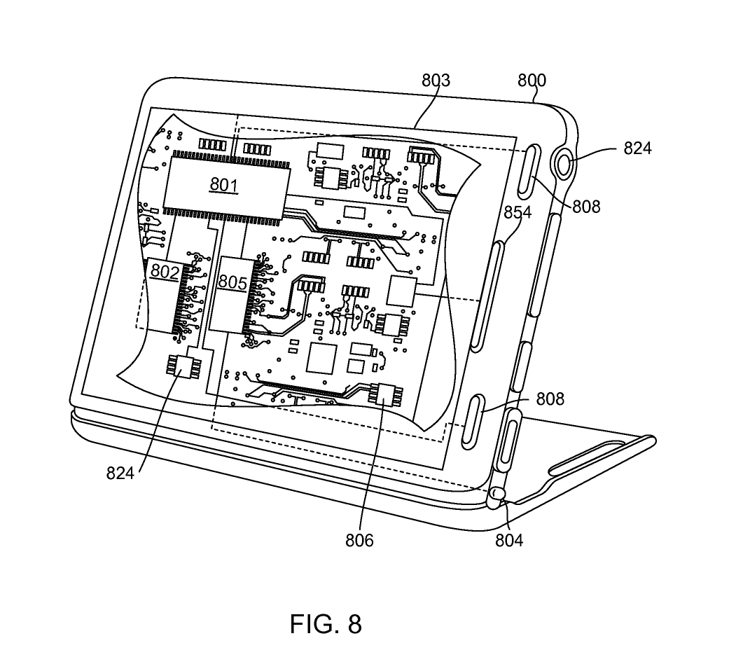

FIG. 8 is a system block diagram of a receiver device suitable for use with any of the embodiments. A typical receiver device 800 may include a processor 801 coupled to internal memory 802, a display 803, and to a speaker 854. Additionally, the receiver device 800 may include an antenna 804 for sending and receiving electromagnetic radiation that may be connected to a wireless data link and/or cellular telephone transceiver 805 coupled to the processor 801 and a mobile multimedia broadcast receiver 806 coupled to the processor 801. Receiver devices 800 typically also include menu selection buttons or rocker switches 808 for receiving user inputs.

The various embodiment methods for receiving and processing interactivity event signaling messages may be performed by the multimedia broadcast receiver 824 and portions of the processor 801 and memory 802. Alternatively dedicated modules within or coupled to the multimedia broadcast receiver 824 may perform the embodiment methods.

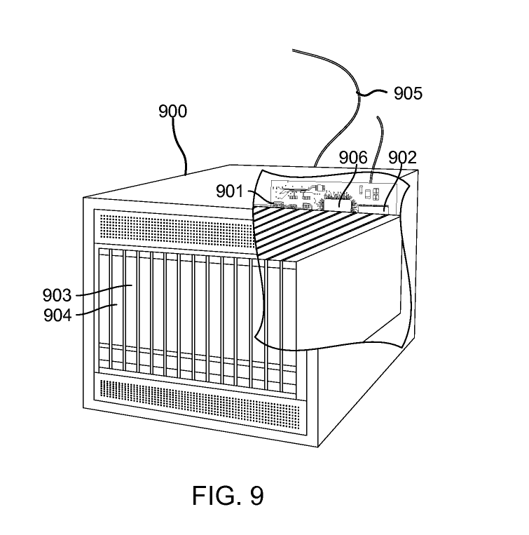

The various embodiments on the broadcast side may be implemented on any of a variety of commercially available server devices, such as the server 900 illustrated in FIG. 9. Such a server 900 typically includes a processor 901 coupled to volatile memory 902 and a large capacity nonvolatile memory, such as a disk drive 903. The server 900 may also include a floppy disc drive, compact disc (CD) or DVD disc drive 906 coupled to the processor 901. The server 900 may also include network access ports 904 coupled to the processor 901 for establishing data connections with a network 905, such as a local area network coupled to other broadcast system computers and servers.

The processors 801, 901 may be any programmable microprocessor, microcomputer or multiple processor chip or chips that can be configured by software instructions (applications) to perform a variety of functions, including the functions of the various embodiments described above. In some mobile receiver devices, multiple processors 801 may be provided, such as one processor dedicated to wireless communication functions and one processor dedicated to running other applications. Typically, software applications may be stored in the internal memory 802, 902, 903 before they are accessed and loaded into the processor 801, 901. The processor 801, 901 may include internal memory sufficient to store the application software instructions.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a computer-readable medium. The steps of a method or algorithm disclosed herein may be embodied in a processor-executable software module which may reside on a non-transitory computer-readable storage medium. Non-transitory computer-readable storage media may be any available media that may be accessed by a computer. By way of example, and not limitation, such non-transitory computer-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of non-transitory computer-readable media. Additionally, the operations of a method or algorithm may reside as one or any combination or set of codes and/or instructions on a non-transitory machine readable storage medium and/or computer-readable storage medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method of broadcasting exclusive real-time content, non-exclusive real-time content, and non-real-time content within transmission frames on multiple radio frequency bands such that a receiver device associated with a first service provider may receive content broadcast on any two or more frequencies, the method comprising:
broadcasting non-real-time content exclusive to the first service provider in a first portion of transmission time on a transmission frame in a first radio frequency band; and
broadcasting exclusive and non-exclusive real-time content of the first service provider in a second portion of a transmission frame on any other radio frequency band.

2. The method of claim 1, wherein exclusive real-time content, non-exclusive real-time content, and non-real-time content for a second provider are also broadcast, the method further comprising:
broadcasting non-real-time content exclusive to the second provider in a third portion of transmission time of a transmission frame in a first radio frequency band such that the non-real-time transmissions of the first and second provider do not overlap; and
broadcasting exclusive and non-exclusive real-time content of the second provider in a second portion of a transmission frame on any other radio frequency band such that the exclusive and non-exclusive real time content do not overlap in time with the third portion of the frame.

3. The method of claim 2, wherein additional service providers broadcast content on the multiple radio frequency bands, the content being organized such that non-real-time traffic for all providers does not overlap in time.

4. The method of claim 3, wherein the broadcast content is organized such that portions of the transmission frame that do not overlap with non-real-time traffic are used for broadcasting non-exclusive real time content.

5. The method of claim 1, wherein exclusive real-time content, non-exclusive real-time content, and non-real-time content for a second provider are also broadcast, the method further comprising:
broadcasting non-real-time content exclusive to the second service provider in a third portion of transmission time of a transmission frame in a first radio frequency band such that non-real-time transmissions of the first and second provider overlap; and
broadcasting exclusive and non-exclusive real time content of the second service provider in a second portion of a transmission frame on any other radio frequency band that does not overlap in time with the third portion of the frame.

6. The method of claim 5, further comprising using time hopping to retrieve broadcast content.

7. The method of claim 5, wherein additional service providers broadcast content on the multiple radio frequency bands, and the content is organized such that non-real time traffic for all providers overlaps.

8. The method of claim 5, wherein the broadcast content is organized such that portions of the frame that do not overlap with any non-real time traffic are used for broadcasting non-exclusive real time content.

9. The method of claim 1, wherein exclusive real-time content, non-exclusive real-time content, and non-real-time content for a second provider are also broadcast, and the broadcast content is organized such that some non-real time traffic for some providers does not overlap and some non-real time traffic for other providers does overlap.

10. The method of claim 1, wherein the transmission frame represents the time-aligned broadcast time blocks on all carriers for a broadcast technology.

11. A broadcast system including a first content provider and a second content provider, the broadcast system comprising:
means for broadcasting non-real-time content exclusive to the first service provider in a first portion of transmission time of a transmission frame in a first radio frequency band; and
means for broadcasting exclusive and non-exclusive real-time content of the first service provider in a second portion of a transmission frame on any other radio frequency band.

12. The broadcast system of claim 11, further comprising:
means for broadcasting non-real-time content exclusive to the second provider in a third portion of transmission time on a transmission frame in a first radio frequency band such that the non-real-time transmissions of the first and second provider do not overlap; and
means for broadcasting exclusive and non-exclusive real-time content of the second provider in a second portion of a transmission frame on any other radio frequency band such that the exclusive and non-exclusive real time content do not overlap in time with the third portion of the frame.

13. The broadcast system of claim 12, wherein the broadcast system includes additional service providers broadcasting content on the multiple radio frequency bands, the broadcast system comprising means for organizing the content such that non-real-time traffic for all providers does not overlap in time.

14. The broadcast system of claim 13, further comprising means for organizing broadcast content such that portions of the frame that do not overlap with non-real-time traffic are used for broadcasting non-exclusive real time content.

15. The broadcast system of claim 11, further comprising:
means for broadcasting non-real-time content exclusive to the second service provider in a third portion of transmission time on a transmission frame in a first radio frequency band such that non-real-time transmissions of the first and second provider overlap; and
means for broadcasting exclusive and non-exclusive real time content of the second service provider in a second portion of a transmission frame on any other radio frequency band that does not overlap in time with the third portion of the frame.

16. The broadcast system of claim 15, wherein the broadcast system includes additional service providers broadcasting content on the multiple radio frequency bands, the broadcast system further comprising means for organizing the broadcast content such that non-real time traffic for all providers overlaps.

17. The broadcast system of claim 16, further comprising means for organizing the broadcast content such that portions of the frame that do not overlap with any non-real time traffic are used for broadcasting non-exclusive real time content.

18. The broadcast system of claim 11, further comprising means for organizing the broadcast content such that some non-real time traffic for some content providers does not overlap and some non-real time traffic for other content providers does overlap.

19. The broadcast system of claim 11, wherein the transmission frame represents the time-aligned broadcast time blocks on all carriers for a broadcast technology.

20. A broadcast system including a first content provider comprising a first server and a second content provider comprising a second content server,
wherein the first server is configured with server-executable instructions to perform operations for controlling broadcast of content by the first content provider comprising:
broadcasting non-real-time content exclusive to the first service provider in a first portion of transmission time of a transmission frame in a first radio frequency band; and
broadcasting exclusive and non-exclusive real-time content of the first service provider in a second portion of a transmission frame on any other radio frequency band.

21. The broadcast system of claim 20, wherein the second server is configured with server-executable instructions to perform operations for controlling broadcast of content by the second content provider comprising:
broadcasting non-real-time content exclusive to the second provider in a third portion of transmission time on a transmission frame in a first radio frequency band such that the non-real-time transmissions of the first and second provider do not overlap; and
broadcasting exclusive and non-exclusive real-time content of the second provider in a second portion of a transmission frame on any other radio frequency band such that the exclusive and non-exclusive real time content do not overlap in time with the third portion of the frame.

22. The broadcast system of claim 21, wherein the broadcast system includes additional service providers broadcasting content on the multiple radio frequency bands, each of the additional service providers comprising a server, wherein the servers of each of the service providers is configured with server-executable instructions to cause its respective service provider to perform operations comprising organizing the content such that non-real-time traffic for all providers does not overlap in time.

23. The broadcast system of claim 22, wherein the servers of each of the service providers is configured with server-executable instructions to cause its respective service provider to perform operations comprising organizing broadcast content such that portions of the frame that do not overlap with non-real-time traffic are used for broadcasting non-exclusive real time content.

24. The broadcast system of claim 20, wherein the second server is configured with server-executable instructions to perform operations for controlling broadcast of content by the second content provider comprising:
broadcasting non-real-time content exclusive to the second service provider in a third portion of transmission time of a transmission frame in a first radio frequency band such that non-real-time transmissions of the first and second provider overlap; and
broadcasting exclusive and non-exclusive real time content of the second service provider in a second portion of a transmission frame on any other radio frequency band that does not overlap in time with the third portion of the frame.

25. The broadcast system of claim 24, wherein the broadcast system includes additional service providers broadcasting content on the multiple radio frequency bands each of the additional service providers comprising a server, wherein the servers of each of the service providers is configured with server-executable instructions to cause its respective service provider to perform operations comprising organizing the broadcast content such that non-real time traffic for all providers overlaps.

26. The broadcast system of claim 25, wherein the servers of each of the service providers is configured with server-executable instructions to cause its respective service provider to perform operations further comprising organizing the broadcast content such that portions of the frame that do not overlap with any non-real time traffic are used for broadcasting non-exclusive real time content.

27. The broadcast system of claim 20, wherein the first server is configured with server-executable instructions to perform operations for controlling broadcast of content by the first content provider further comprising means for organizing the broadcast content such that some non-real time traffic for some content providers does not overlap and some non-real time traffic for other content providers does overlap.

28. The broadcast system of claim 20, wherein the transmission frame represents the time-aligned broadcast time blocks on all carriers for a broadcast technology.

29. A non-transitory server-readable storage medium having stored thereon server-executable instructions configured to cause a server of a first content provider in a broadcast system to perform operations for controlling broadcast of content by the first content provider comprising:
broadcasting non-real-time content exclusive to the first service provider in a first portion of transmission time of a transmission frame in a first radio frequency band; and
broadcasting exclusive and non-exclusive real-time content of the first service provider in a second portion of a transmission frame on any other radio frequency band.

30. The non-transitory server-readable storage medium of claim 29, wherein the broadcast system includes a second server and the stored server-executable instructions are configured to cause a server of the second content provider to perform operations for controlling broadcast of content by the second content provider comprising:
broadcasting non-real-time content exclusive to the second provider in a third portion of transmission time of a transmission frame in a first radio frequency band such that the non-real-time transmissions of the first and second provider do not overlap; and
broadcasting exclusive and non-exclusive real-time content of the second provider in a second portion of a transmission frame on any other radio frequency band such that the exclusive and non-exclusive real time content do not overlap in time with the third portion of the frame.

31. The non-transitory server-readable storage medium of claim 30, wherein the broadcast system includes additional service providers broadcasting content on the multiple radio frequency bands, each of the additional service providers comprising a server, wherein the stored server-executable instructions are configured to cause a server of the content providers to perform operations for controlling broadcast of content comprising organizing the content such that non-real-time traffic for all providers does not overlap in time.

32. The non-transitory server-readable storage medium of claim 31, wherein the stored server-executable instructions are configured to cause a server of the content providers to perform operations for controlling broadcast of content comprising organizing broadcast content such that portions of the frame that do not overlap with non-real-time traffic are used for broadcasting non-exclusive real time content.

33. The non-transitory server-readable storage medium of claim 29, wherein the broadcast system includes a second server and the stored server-executable instructions are configured to cause a server of the second content provider to perform operations for controlling broadcast of content by the second content provider comprising:
broadcasting non-real-time content exclusive to the second service provider in a third portion of transmission time of a transmission frame in a first radio frequency band such that non-real-time transmissions of the first and second provider overlap; and
broadcasting exclusive and non-exclusive real time content of the second service provider in a second portion of a transmission frame on any other radio frequency band that does not overlap in time with the third portion of the frame.

34. The non-transitory server-readable storage medium of claim 33, wherein the broadcast system includes additional service providers broadcasting content on the multiple radio frequency bands, each of the additional service providers comprising a server, wherein the stored server-executable instructions are configured to cause a server of the content providers to perform operations for controlling broadcast of content comprising organizing the broadcast content such that non-real time traffic for all providers overlaps.

35. The non-transitory server-readable storage medium of claim 34, wherein the stored server-executable instructions are configured to cause a server of the content providers to perform operations for controlling broadcast of content comprising organizing the broadcast content such that portions of the transmission frame that do not overlap with any non-real time traffic are used for broadcasting non-exclusive real time content.

36. The non-transitory server-readable storage medium of claim 29, wherein the stored server-executable instructions are configured to cause a server of the first content provider to perform operations for controlling broadcast of content by the first content provider further comprising organizing the broadcast content such that some non-real time traffic for some content providers does not overlap and some non-real time traffic for other content providers does overlap.

37. The non-transitory server-readable storage medium of claim 29, wherein the transmission frame represents the time-aligned broadcast time blocks on all carriers for a broadcast technology.

38. A receiver device configured to receive on any two or more frequencies exclusive real-time content, non-exclusive real-time content, and non-real-time content broadcast within single transmission frames on multiple radio frequency bands.

39. The receiver device of claim 38, wherein the receiver device is configured to use time hopping to retrieve the exclusive real-time content, non-exclusive real-time content, and non-real-time content.

40. A receiver device, comprising means for receiving on any two or more frequencies exclusive real-time content, non-exclusive real-time content, and non-real-time content broadcast within single transmission frames on multiple radio frequency bands.

41. The receiver device of claim 40, wherein means for receiving comprises means for receiving using time hopping to retrieve the exclusive real-time content, non-exclusive real-time content, and non-real-time content within single transmission frames.

42. A non-transitory processor-readable storage medium having stored thereon processor-executable instructions configured to cause a processor of a receiver device to perform operations comprising:
receiving on any two or more frequencies exclusive real-time content, non-exclusive real-time content, and non-real-time content broadcast within single transmission frames on multiple radio frequency bands.

43. The non-transitory processor-readable storage medium of claim 29, wherein the stored processor-executable instructions are configured to cause a processor of a receiver device to perform operations further comprising using time hopping to retrieve the exclusive real-time content, non-exclusive real-time content, and non-real-time content.
